(19) United States
(12) Patent Application Publication
(10) Pub. No.: US 2007/0230455 A1
(43) Pub. Date: Oct. 4, 2007

(54) NETWORK DEVICE AND METHOD FOR MIRRORING PACKETS

(75) Inventors: CHENG-YI HSIEH, Shenzhen (CN); YU-CHENG LIN, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,772

(22) Filed: Sep. 22, 2006

(30) Foreign Application Priority Data
Mar. 31, 2006 (TW) 095111404

(51) Int. Cl. H04L 12/56

(52) U.S. Cl. 370/389

(57) ABSTRACT

A network device for forwarding packets includes a plurality of interfaces including at least a source interface and a destination interface and a bridge module. The bridge module includes a receiving sub-module, a parsing sub-module, and a sending sub-module. The receiving sub-module receives a packet via the source interface. The parsing sub-module includes a media access control (MAC) table for saving MAC addresses and identifiers of interfaces corresponding to the MAC addresses, parses the packet to retrieve a destination MAC address of the packet, and queries the MAC table to retrieve an identifier of the destination interface. The sending sub-module receives the packet and the identifier of the destination interface, and sends the packet to the destination interface. The parsing sub-module determines whether the network device has an interface mirroring function, and sends the packet to a mirror interface if the network device has the interface mirroring function.

### 1. FIELD OF THE INVENTION

The invention relates to network devices, and particularly to a network device and a method for mirroring packets.

### 2. DESCRIPTION OF RELATED ART

The network has become more and more popular due to convenience thereof, and a size of the network is increasing. Therefore, management is required to maintain network performance, thereby maintaining normal communications of users of the network. Integrated access devices (IAD) are used for accessing the network, therefore, it is very important to manage the IADs. A conventional management method employs port mirroring (also known as interface mirroring); that is, all packets through a network device are copied to a predetermined interface to manage traffic flow of the network device.

However, mirroring ports of the conventional management method are implemented by hardware. For example, users of the network devices may use hard disks to copy packets through the network devices. Thus, it is inconvenient for the users.

### SUMMARY OF THE INVENTION

An embodiment of the invention provides a network device for forwarding packets. The network device includes a plurality of interfaces and a bridge module. The plurality of interfaces includes at least a source interface and a destination interface. The bridge module includes a receiving sub-module, a parsing sub-module, and a sending sub-module. The receiving sub-module is for receiving a packet via the source interface. The parsing sub-module includes a media access control (MAC) table for saving MAC addresses and identifiers of interfaces corresponding to the MAC addresses. The parsing sub-module is for parsing the packet received by the receiving sub-module to retrieve a destination MAC address of the packet and querying the MAC table to retrieve an identifier of the destination interface corresponding to the destination MAC address. The sending sub-module is connected to the parsing sub-module, and is for receiving the packet and the identifier of the destination interface and sending the packet to the destination interface. The parsing sub-module is further used for determining whether the network device has an interface mirroring function and sending the packet to a mirror interface of the plurality of interfaces if the network device has the interface mirroring function.

Another embodiment of the invention provides a method for mirroring packets for utilization in a network device. The method includes receiving a packet via a source interface, and sending the packet to a parsing sub-module, the parsing sub-module comprising a media access control (MAC) table for saving MAC addresses and identifiers of interfaces corresponding to the MAC addresses; parsing the packet to retrieve a destination MAC address of the packet; querying the MAC table to retrieve an identifier of a destination interface corresponding to the destination MAC address; sending the packet and the identifier of the destination interface to a sending sub-module; sending the packet to the destination interface; determining whether the network device has an interface mirroring function; and sending the packet to a mirror interface.

Other advantages and novel features will become more apparent from the following detailed description when taken in conjunction with the accompanying drawings.

### BRIEF DESCRIPTION OF THE DRAWINGS

FIG. 1 is a schematic diagram of a network communication device of an exemplary embodiment of the invention.

FIG. 2 shows a flowchart of a method for mirroring packets of another exemplary embodiment of the invention.

### DETAILED DESCRIPTION OF THE INVENTION

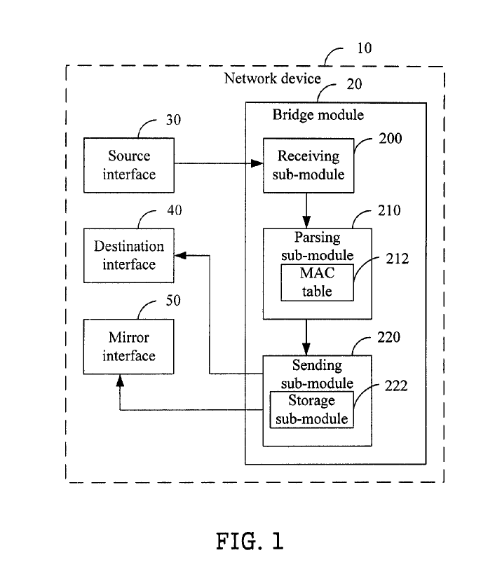

FIG. 1 is a schematic diagram of a network device 10 of an exemplary embodiment of the invention. In the exemplary embodiment, the network device 10 may be an integrated access device (IAD). The network device 10 forwards packets, and includes a plurality of interfaces (only a source interface 30, a destination interface 40, and a mirror interface 50 are shown in FIG. 1) and a bridge module 20. The network device 10 forwards packets via the interfaces.

The bridge module 20 receives packets from one of the interfaces, parses the packets to retrieve destination interfaces thereof, sends the packets to the destination interfaces, determines whether the network device 10 has an interface mirroring function, and sends the packets to a mirror interface if the network device 10 has the interface mirroring function. The bridge module 20 includes a receiving sub-module 200, a parsing sub-module 210, and a sending sub-module 220. The receiving sub-module 200 receives the packets via one of the interfaces, that is, the source interface 30, and sends the packets to the parsing sub-module 210.

The parsing sub-module 210 is connected to the receiving sub-module 200, and includes a media access control (MAC) table 212. The MAC table 212 saves MAC addresses and identifiers of interfaces corresponding to the MAC addresses. The parsing sub-module 210 is used for receiving the packets from the receiving sub-module 200, parsing the packets to retrieve destination MAC address thereof, querying the MAC table 212 to retrieve identifiers of destination interfaces corresponding to the destination MAC addresses, and sending the packets and the identifiers of the destination interfaces to the sending sub-module 220.

The sending sub-module 220 is connected to the parsing sub-module 210, and is used for receiving the packets and the identifiers of the destination interfaces and sending the packets to the destination interfaces. The sending sub-module 220 is further used for determining whether the network device 10 has the interface mirroring function and sending the packets to the mirror interface 50 if the network device 10 has the interface mirroring function.

In the exemplary embodiment, the receiving sub-module 200 receives a packet from the source interface 30, and sends the packet to the parsing sub-module 210. The parsing sub-module 210 parses the packet to retrieve a destination MAC address of the packet, queries the MAC table 212 to retrieve an identifier of the destination interface 40 corresponding to the destination MAC address, and sends the packet and the identifier to the sending sub-module 220. The sending sub-module 220 sends the packet to the destination interface 40 according to the identifier. Then the sending sub-module 220 determines whether the network device 10 has an interface mirroring function, and sends the packet to the mirror interface 50 if the network device 10 has the interface mirroring function. If the parsing sub-module 210 does not retrieve an identifier of a destination interface corresponding to the destination MAC address, that is, there is no interface corresponding to the destination MAC address in the MAC table 212, the sending sub-module 220 sends the packet to all interfaces of the network device 10.

In alternative embodiments, the receiving sub-module 200 is further used for sending an identifier of the source interface 30 to the parsing sub-module 210. The parsing sub-module 210 is further used for saving the identifier of the source interface 30 and the source MAC address in the MAC table 212. If there is a matching MAC address and a matching identifier already stored in the MAC table 212, the parsing sub-module 210 does not save the identifier of the source interface 30 and the source MAC address. Therefore, duplicate entries are not made allowing a greater amount of unique MAC addresses to be stored in the MAC table 212, thereby decreasing possibility of having to send packets to all interfaces of the network device 10 and increasing efficiency of packet forwarding.

The sending sub-module 220 includes a storage sub-module 222 for saving status data of the interface mirroring function of the network device 10 and an identifier of the mirror interface 50. The status of the interface mirroring function includes an enable status (having the interface mirroring function), and a disable status (having no interface mirroring function). In the exemplary embodiment, the enable status is represented by 1, and the disable status is represented by 0. In other embodiments, the enable status and the disable status may be represented by other different digits and/or letters. The sending sub-module 220 finds whether the network device 10 has the interface mirroring function by reading the status data from the storage sub-module 222. The sending sub-module 220 further finds whether the mirror interface 50 is the same as the destination interface 40. The sending sub-module 220 sends the packet to the mirror interface 50 if the mirror interface 50 is not the same as the destination interface 40, otherwise, the sending sub-module 220 does not send the packet to the mirror interface 50.

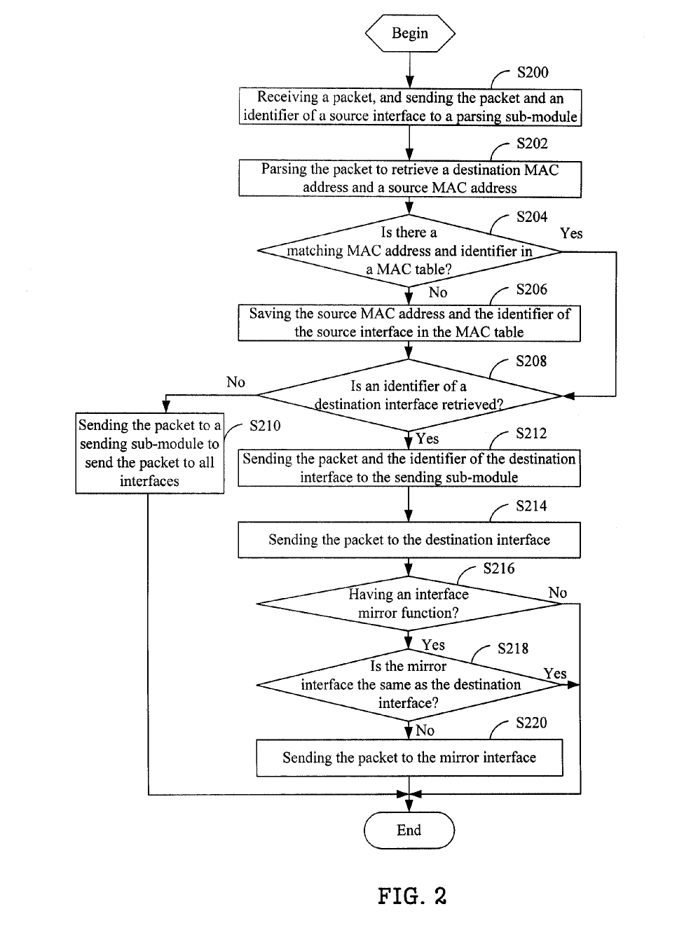

FIG. 2 is a flowchart of a method for mirroring packets of an exemplary embodiment of the invention. In step S200, the receiving sub-module 200 receives a packet via the source interface 30, and sends the packet and an identifier of the source interface 30 to the parsing sub-module 210. In step S202, the parsing sub-module 210 receives the packet and the identifier of the source interface 30, and parses the packet to retrieve a destination MAC address and a source MAC address thereof. In step S204, the parsing sub-module 210 determines whether there is a matching MAC address and a matching identifier in the MAC table 212 with the source MAC address of the packet and the identifier of the source interface 30. If yes, the process directly goes to step S208.

If not, in step S206, the parsing sub-module 210 saves the source MAC address of the packet and the identifier of the source interface 30 in the MAC table 212. In step S208, the parsing sub-module 210 queries the MAC table 212 to retrieve an identifier of the destination interface 40 corresponding to the destination MAC address, and determines whether an identifier of the destination interface 40 is retrieved. If no identifier of the destination interface 40 is retrieved, in step S210, the parsing sub-module 210 sends the packet to the sending sub-module 220 to send the packet to all interfaces of the network device 10. If the identifier of the destination interface 40 is retrieved, in step S212, the parsing sub-module 210 sends the packet and the identifier of the destination interface 40 to the sending sub-module 220. In step S214, the sending sub-module 220 sends the packet to the destination interface 40 according to the received identifier of the destination interface 40.

In step S216, the sending sub-module 220 reads the status data of the interface mirroring function of the network device 10 from the storage sub-module 222, and determines whether the network device 10 has the interface mirroring function. If the network device 10 has no interface mirroring function, the process ends. If the network device 10 has the interface mirroring function, in step S218, the sending sub-module 220 reads an identifier of the mirror interface 50 from the storage sub-module 222, and determines whether the mirror interface 50 is the same as the destination interface 40. If the mirror interface 50 is the same as the destination interface 40, the process ends. If the mirror interface 50 is different from the destination interface 40, in step S220, the sending sub-module 220 sends the packet to the mirror interface 50.

According to the network device 10 and the method for mirroring packets, traffic of the network device 10 can be managed via a device connected to the mirror interface 50 directly. It is convenient for managers.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A network device for forwarding packets, comprising:
a plurality of interfaces, the plurality of interfaces comprising at least a source interface and a destination interface; and
a bridge module, comprising:
a receiving sub-module, for receiving a packet via the source interface;
a parsing sub-module, comprising a media access control (MAC) table for saving MAC addresses and identifiers of interfaces corresponding to the MAC addresses, for parsing the packet received by the receiving sub-module to retrieve a destination MAC address of the packet and querying the MAC table to retrieve an identifier of the destination interface corresponding to the destination MAC address; and
a sending sub-module connected to the parsing sub-module, for receiving the packet and the identifier of the destination interface and sending the packet to the destination interface;
wherein the parsing sub-module is further used for determining whether the network device has an interface mirroring function and sending the packet to a mirror interface of the plurality of interfaces if the network device has the interface mirroring function.

2. The network device of claim 1, wherein the sending sub-module is further used for sending an identifier of the source interface to the parsing sub-module.

3. The network device of claim 2, wherein the parsing sub-module is further used for parsing the packet to retrieve a source MAC address of the packet and saving the source MAC address and the identifier of the source interface in the MAC table.

4. The network device of claim 1, wherein the sending sub-module comprises a storage sub-module for saving status data of the interface mirroring function of the network device.

5. The network device of claim 4, wherein the status of the interface mirroring function comprises an enable status and a disable status.

6. The network device of claim 4, wherein the sending sub-module reads the status data from the storage sub-module, and finds whether the network device has the interface mirroring function.

7. The network device of claim 1, wherein the sending sub-module is further used for finding whether the mirror interface is the same as the destination interface of the packet.

8. The network device of claim 1, wherein the network device comprises an integrated access device.

9. A method for mirroring packets for utilization in a network device, comprising:
receiving a packet via a source interface, and sending the packet to a parsing sub-module, the parsing sub-module comprising a media access control (MAC) table for saving MAC addresses and identifiers of interfaces corresponding to the MAC addresses;
parsing the packet to retrieve a destination MAC address of the packet;
querying the MAC table to retrieve an identifier of a destination interface corresponding to the destination MAC address;
sending the packet and the identifier of the destination interface to a sending sub-module;
sending the packet to the destination interface;
determining whether the network device has an interface mirroring function; and
sending the packet to a mirror interface.

10. The method for mirroring packets of claim 9, further comprising steps of:
sending an identifier of the source interface to the parsing sub-module;
parsing the packet to retrieve a source MAC address of the packet;
determining whether there is a matching MAC address and a matching identifier in the MAC table with the source MAC address of the packet and the identifier of the source interface; and
saving the source MAC address and the identifier of the source interface in the MAC table if not.

11. The method for mirroring packets of claim 9, wherein the step of determining whether the network device has the interface mirroring function comprises reading status data of the interface mirroring function from a storage sub-module to determine whether the network device has the interface mirroring function.

12. The method for mirroring packets of claim 11, wherein status of the interface mirroring function comprises an enable status and a disable status.

13. The method for mirroring packets of claim 9, further comprising a step of determining whether the mirror interface is the same as the destination interface of the packet.

14. The method for mirroring packets of claim 13, further comprising a step of sending no packets to the mirror interface if the mirror interface is the same as the destination interface.

15. The method for mirroring packets of claim 9, further comprising a step of determining whether an identifier of the destination interface is retrieved.

16. The method for mirroring packets of claim 15, further comprising a step of sending the packet to the sending sub-module to send the packet to all interfaces of the network device.

17. A method for mirroring transmissible packets for further use, comprising:
maintaining a media access control (MAC) table comprising MAC addresses of interfaces where transmissible packets are able to transmit thereto and therefrom, and identifiers of said interfaces corresponding to said MAC addresses, respectively;
receiving a packet via a source interface;
parsing said received packet to retrieve a destination MAC address of a destination interface of said packet;
querying said MAC table to retrieve an identifier of said destination interface corresponding to said parsed destination MAC address;
sending said packet to all available interfaces including a mirror interface when said parsed destination MAC address of said packet is not in said MAC table; and
sending said packet to said destination interface based on said retrieved corresponding identifier of said parsed destination MAC address and then sending said packet to said mirror interface when said parsed destination MAC address of said packet is in said MAC table.

18. The method of claim 17, further comprising steps of:
parsing said received packet to retrieve a source MAC address of said source interface after said packet is received via said source interface; and
saving said source MAC address and a corresponding identifier of said source interface in said MAC table when said source MAC address and said corresponding identifier are not available in said MAC table.
